(19) United States
(12) Patent Application Publication
(10) Pub. No.: US 2014/0208902 A1
(43) Pub. Date: Jul. 31, 2014

(54) LEATHER PROCESS AUTOMATION FOR DIE CUTTING OPERATIONS

(71) Applicant: Gerber Scientific International, Inc., Tolland, CT (US)

(72) Inventor: Thomas A. Gordon, Glastonbury, CT (US)

(73) Assignee: Gerber Scientific International, Inc., Tolland, CT (US)

(21) Appl. No.: 14/167,456

(22) Filed: Jan. 29, 2014

Related U.S. Application Data
(60) Provisional application No. 61/758,015, filed on Jan. 29, 2013.

(51) Int. Cl. C14B 5/02

(52) U.S. Cl. CPC C14B 5/02
USPC 83/13; 83/821

(57) ABSTRACT

A processing system for processing a leather hide includes a laser system configured for illuminating the leather hide with location information for placement of a die. A method of processing and a computer program product are also disclosed.

### CROSS-REFERENCE TO RELATED APPLICATION

This patent application claims the benefit of priority to U.S. Provisional application Ser. No. 61/758,015, filed Jan. 29, 2013. The aforementioned patent application is incorporated by reference herein in its entirety for any purpose whatsoever.

### BACKGROUND

1. Field

The present disclosure relates to the automation of leather die cutting operations.

2. Description of the Related Art

Traditional leather die cutting is done today much as it has been done for centuries. Steel bands with sharpened edges are fabricated and welded in the shape of desired parts which are ultimately assembled for use in automobile or furniture seating, clothing, footwear, and accessories. A group of individual dies are manually placed by human operators on a leather animal hide which has been spread onto a rigid and flat board. The operators must respect the natural and irregular peripheral edges of the leather hides and strategically place each uniquely shaped die in order to avoid defects. Many of the defects on the leather hides have been identified and marked by human inspectors in a prior inspection process. Defects in the hides can be in the form of scars, rips, voids, or other undesirable areas not allowed or desired in the finished goods, products or articles. The operator's skill and allotted time for the die placing operation influence the amount of leather usage and ultimately affect the cost of the finished goods. Thus, it is desirable to automate the die cutting process by minimizing the amount of leather used while maximizing workflow throughput.

The traditional die cutting workflow processes include: recognizing the numbers of each individual dies or parts that are required for a specific job order; continually managing the tally of the number of completed parts against the number required for each part in the job order list; manually locating a first die of a proper shape from a storage rack and subsequently placing the first die in an acceptable region on the hide; locating additional dies of proper shapes from the storage rack and positioning the dies on the hide in acceptable regions; and continuing to locate and nest the proper shape of dies in such proximity to the previously placed dies in order to maximize the overall material utilization of the entire hide.

From time to time dies may require re-positioning to allow for the use of additional dies. For example, a previously placed die may need to be removed and substituted for another die in order to maintain proper unit part count. Die inventory also impacts material utilization, and often times, a required die may not be available which may result in the hide having an unused and open area. In other situations, a substitute die from a different job order may need to be located and used to rectify the open area and/or maintain proper unit part count. Likewise, required dies can be located and borrowed from other die stations or that are being used for other job orders.

Once the maximum number of proper dies is placed on the hide, the assembly consisting of the die board, hide, and dies is sent to a press. The dies are forced through the press and pressed onto leather hide resulting in a batch of individual parts of hide, each part corresponding to the placed dies. The die board is then removed from the press and the operators must manually remove the dies and return them to the storage rack. Operators then sort and bundle like parts into kits which are ultimately used to complete the manufacturing process. The above sequence continues until sufficient numbers of each part are die cut so as to complete the job order.

Clearly, the foregoing process is time consuming and is not exacting. Thus, what are needed are methods and apparatus to improve the efficiency of leather cutting operations. Preferably, the techniques are automated and provide for selection and alternation of dies, imperfections and variations in leather hides and increased throughput.

### SUMMARY

In one embodiment, a processing system for processing a leather hide is disclosed. The processing system includes a laser system configured for illuminating the leather hide with location information for placement of a die.

In another embodiment, a method for processing a leather hide is disclosed. The method includes illuminating the leather hide with location information from a laser system; and, placing at least one die upon the leather hide according to the location information.

In yet another embodiment, a computer program product stored on machine readable media, the computer program product including machine executable instructions for processing a leather hide is provided. The instructions include instructions for operating a laser system for illuminating the leather hide with location information; and, adjusting operation of the laser system according to user input.

In some implementations, a processing system for processing a leather hide is provided that includes a laser system configured for illuminating the leather hide with location information for placement of a die. The system can include one or more of a camera, at least one laser projector, and a controller. The location information can be displayed as at least one of a graphic, a symbol, text, a design and a combination thereof. The laser system can be further configured to illuminate the leather hide with at least one interactive display component. The interactive display component can include a menu. The laser system can be configured to receive interactive input as a reflected beam, a separate graphic user interface, voice recognition, and sensing components within a table supporting the leather hide. The system can further include machine readable instructions for correlating placement of a plurality of dies with a job description, machine readable instructions for identifying at least one defect in the leather hide, machine readable instructions for mapping all defects in the leather hide, and/or readable instructions for correlating a defect map with the leather hide. In some implementations, the location information can account for defects identified within the defect map.

In other implementations, a method for processing a leather hide is provided. The method can include illuminating the leather hide with location information from a laser system, and placing at least one die upon the leather hide according to the location information. The method can further include pressing the at least one die into the leather hide to provide at least one workpiece. The illuminating can further include providing at least one of a menu, an icon, a symbol, text, a design and a combination thereof. The method can still further include receiving user input and adjusting the illuminating according to the input. If desired, the method can include mapping placement of a plurality of dies upon the leather hide to reduce scrap material. If desired, the location information can be determined according to defect information for the leather hide. The illuminating and placing can, if desired, proceed one die at a time until a user has provided for use of the entire leather hide.

The system also provides a computer program product stored on non-transient machine readable media, the computer program product having machine executable instructions for processing a leather hide. The instructions can include instructions for performing any suitable function of this disclosure, but preferably includes instructions for operating a laser system for illuminating the leather hide with location information; and, adjusting operation of the laser system according to user input.

Various other aspects and embodiments of the disclosure are described in further detail below. It has been contemplated that features of one embodiment of the disclosure may be incorporated in other embodiments thereof without further recitation. This Summary is neither intended nor should be construed as being representative of the full extent and scope of the present disclosure. All objects, features and advantages of the present disclosure will become apparent in the following detailed written description and in conjunction with the accompanying drawings.

### BRIEF DESCRIPTION OF THE DRAWINGS

The features and advantages of the disclosed embodiments are apparent from the following description taken in conjunction with the accompanying drawings in which:

FIG. 1 schematically shows a work space for a large laser assisted operation;

FIGS. 2A-2C, collectively referred to herein as FIG. 2, depict aspects of layout of a work area for the operation depicted in FIG. 1; and,

FIG. 3 is a perspective view of an embodiment of the system with a digital camera and laser projector mounted over a die cutting table.

### DETAILED DESCRIPTION

Disclosed herein are methods and apparatus for providing automation of leather cutting processes. The techniques disclosed provide for, among other things: recognizing the number of each individual part required for a job order; managing the number of individual parts throughout the process to ensure that the desired number of each part is produced; locating the proper die required to manage the desired number of each part to be produced; nesting the proper dies so as to minimize the amount of leather required to satisfy each job order, returning used dies to their storage racks; and inventorying used dies for quick locating for the next use cycle.

Prior to discussing aspects of the methods and apparatus in detail, a non-limiting overview of the methods and apparatus is provided. That is, in other embodiments, the method and apparatus may deviate from the embodiments described in this overview.

In general, a system for leather cutting processes includes a digital camera, mounted over a die cutting table which contains a leather hide. The digital camera is configured to view the entirety of the hide when it is laid flat. The camera is therefore able to capture the overall shape of the leather hide and recognize pre-marked flaws in the leather hide that result from a pre-inspection process. The captured image data is transmitted and processed by a computer of the system. The computer may be wired or non-wired to the die cutting table. The captured image data can be displayed through an application interface (API) as a digital representation of shapes that correlate to dies for respective job order requirements. Likewise, the API can be programmed with the number of pieces required of each part for each job order.

The overall shape of the leather hide and a marked defect map may be processed using instructions stored on the computer of the system. The instructions determine the die shapes to be selected and projects the die shapes onto the leather hide via a ceiling mounted laser projector which is connected to the computer. Generally, the instructions perform selection and positioning of the die shapes on the leather hide such to minimize the amount of leather used (that is, to reduce scrap leather). A laser of the projector may be configured to locate and to point to a specific die in a storage repository and direct the human operator to its location on the storage rack. The projector can recognize when a particular die is removed from a storage rack by a human operator and project the shape of a specific die to the proper location, position and orientation on the hide.

The system can recognize an individual die and can confirm that the correct die is placed in the correct location and position. The system can determine if an individual die is incorrectly placed. Incorrect location and placement of dies will result in an audio error warning and/or fault message that is displayed on the API, projected image of the leather hide or on the projector or digital camera. Once a die is properly placed on the leather hide an operator may signal the system's digital camera, API or laser projector via an audio, manual or remote command that the system may select the next die to be placed on the leather hide. Alternatively, the system can be programmed to automatically move on to the next die after a proper placement without an operators prompt. In another embodiment, the system may direct an operator to the location of additional properly shaped dies in storage and once retrieved by the operator, the system may instruct the operator where on the hide to place the die. This automated process continues until the hide is filled with the maximum number of dies. Once the maximum number of proper dies is placed on the hide, the assembly consisting of the die board, hide, and dies is sent to the press. The dies are forced through the press and pressed onto leather hide resulting in a batch of individual parts of hide, each part corresponding to the placed dies. The above sequence continues until the sufficient numbers of each part are die cut so as to complete the job order. Projected iconic feedback to a laser projection system is disclosed in U.S. Pat. No. 5,957,559, issued Sep. 28, 1999 and U.S. Pat. No. 6,036,319, issued Mar. 14, 2010. The disclosure of each of the aforementioned patents is incorporated by reference herein for any purpose whatsoever.

The resulting parts of the hide may be referred to as a “workpiece,” or as a “product,” or by other similar terminology.

In another embodiment, the system includes an off-line digital scanner which may be used in the inspection phase of the leather hide. The system may also include a ceiling mounted (or other elevated system) digital camera and laser projector. During inspection, the inspector uses a stylus to encircle flaws and defects on the leather hide. The digital scanner is able to capture and recognize the images of the encircled flaws on the leather hide. The computer processes the captured images of the path followed by the stylus. The laser projector then “draws” the path around each individual defect as drawn by the stylus. A series of icons are then projected onto to the leather hide's surface corresponding to the individual defects. An icon need not correspond to a specific defect. For example, an icon may be used to transmit information to the computer system such that the next marked defect will be categorized as Grade IV while another icon may be used to restore the system to a default setting of Grade I. In another embodiment, an icon may provide notification to the system that the next defect will be marked with a particular shape of a particular measurement. For example, the defect may be marked with a circle having a diameter of 1 millimeter (mm). Furthermore, icons can be programmed with specific logic commands. As an example, the operator need only draw a dot on the defect of the leather hide. The dot icon command may then be interpreted by the system to draw a circle around the marked defect with a diameter of 1 mm. Other icons may be programmed to command the system to draw circles of any given size. Specific icons may command the system to draw increasingly larger circles based on the length of time the operator holds the curser in a given location on the hide. Other examples of icon feedback which may be used to control the API and/or system include; identifying different flaw zones, locating and positioning proper die shapes, allowing for the manual movement of parts in the nest of the die cutting table, or any other desired functionality.

Consider now aspects of a laser projection system appropriate for use in leather cutting operations. Note that the laser projection system is useful for a variety of operations.

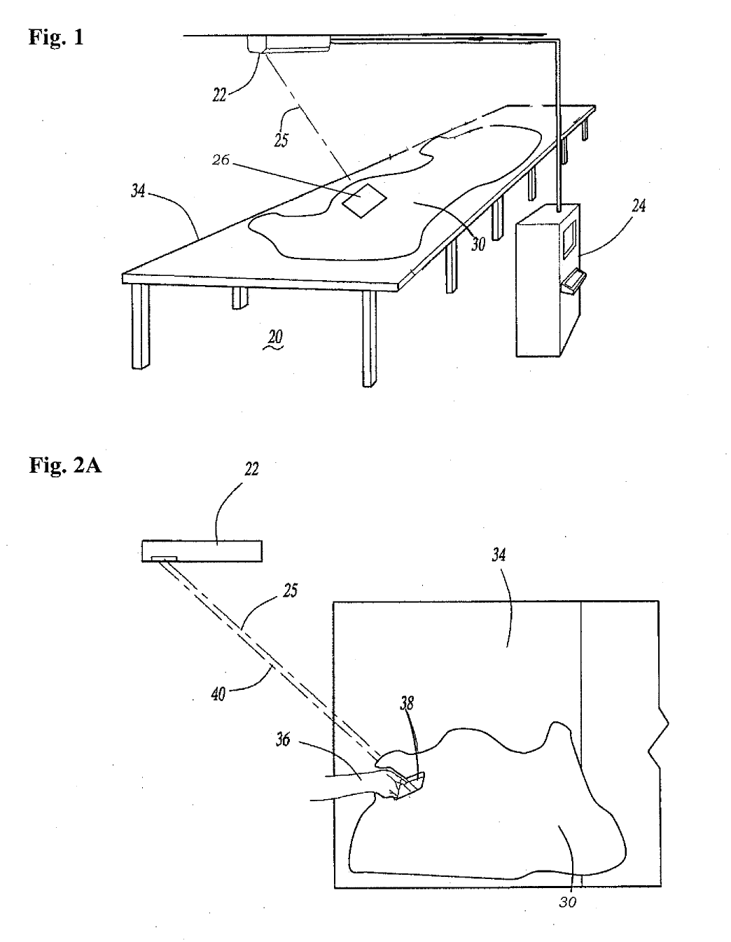

FIG. 1 shows a laser system 20 including at least one laser projector 22 is shown. A controller 24 is operable to drive the at least one laser projector 22 and achieve a desired scanned image. An exemplary controller 24 includes a computer, such as a personal computer. A laser beam 2₅ projects an image 26 (i.e., an image that represents a desired graphic, symbol, text, design or combination thereof). In this case, the image 26 includes the outline of a die for cutting a leather hide ₃o. It should be understood that outlines of a given leather hide ₃o may be more or less complex than the depicted images 26. For purposes of understanding this application, image 26 is shown in a simplified form. The laser system 20 may include interactive display components (such as a menu) as discussed below.

The controller 24 (e.g., a computer) is operable to change the image 26 to be displayed by the at least one laser projector 22. Generally, the controller 24 is flexible and versatile. That is, for example, the controller 24 may be configured to simultaneously display a plurality of unique images 26. The controller 24 may be adjusted, such that certain ones of the images 26 may be modified, moved, omitted, added or otherwise adjusted while projecting onto table 34.

Generally, the controller 24 includes a computer system. Exemplary computer systems include systems running the Microsoft Windows environment, an environment available from Apple Computer, an environment such as Linux or other appropriate type of system. The computer may include other components as are known in the art. For example, the computer may include any one or more of the following: at least one processor, memory, data storage, a user interface (including a keyboard, a video output, a screen, a pointing device such as a mouse, a connection to a printing device, a printer) a network interface, a clock and a power supply. Generally, the controller 24 is configured with machine executable instructions stored on machine readable media, the instructions provided for execution of a method. These instructions may also be referred to as “software.” The instruction sets, or software, may include stand-alone programs, or programs that operate in conjunction with other programs such as an operating system. The controller 24 may further include software and other components necessary for operating specific apparatus such as the laser system 20, a sensor, a camera, and other such components.

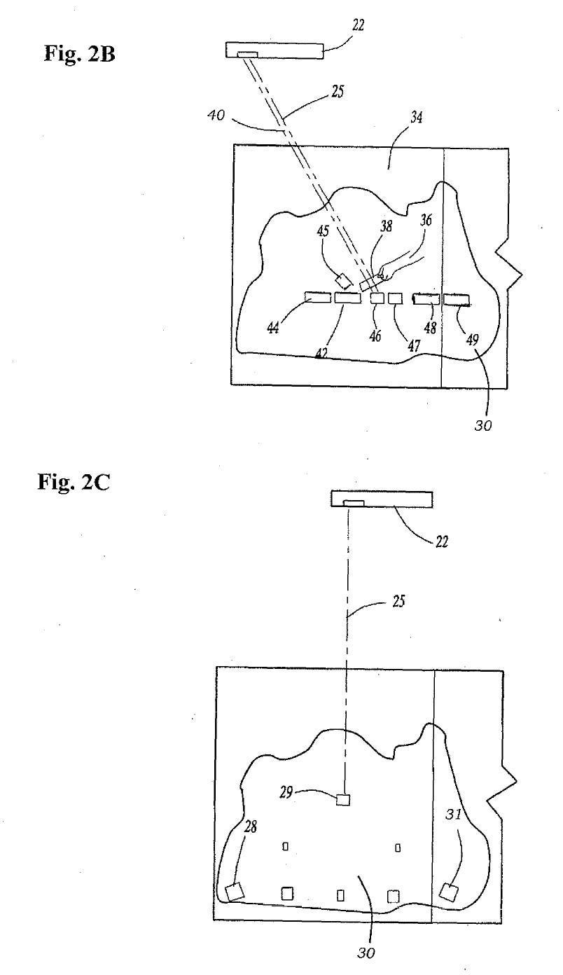

In one embodiment of the laser system 20, as shown in FIG. 2A, an operator 36 places a reflector 38 into the path of the beam 25. Here, the operator 36 is shown working at leather hide 30. When reflector 38 is placed in the path of the beam 25, a reflected beam 40 travels back to the laser projector 22. Generally, the laser projector 22 includes several features such as may be provided with a laser projector system. In particular, the laser projector 22 may be provided with a laser generator, a galvanometer, and at least a sensor (not shown) for sensing the reflected beam 40. The sensor captures the reflected beam 40, and sends an appropriate signal to the controller 24.

As shown in FIG. 2B, the controller 24 has identified a request signal for a menu. The controller 24 responds by driving the laser projector 22 to modify the path of beam 25, and to display a menu 42 on table 34. It should be understood, that the menu can be displayed in any area on the workspace. The menu may be displayed at the area where the operator 36 has initially requested the menu by sending the reflected beam 40. This will ensure that the menu 42 is provided adjacent to where the operator 36 is performing the work.

Interaction with the laser system 20, and the interactive display components, may be achieved through a variety of techniques. For example, by use of the reflector 38 and the reflected beam 40, through a separate user input (such as an external graphic user interface that mimics the interactive display components), through voice recognition, sensing components within the table 34 (such as those configured to sense pressure upon a given menu icon image) and through any one or more of a variety of input devices.

As shown in FIG. 2B, menu 42 may include a plurality of icons 44, 45, 46, 47, 48 and 49. The icons 44-49 may be provided by the laser beam 25 as images. The icons 44-49 provide the operator with the ability to select from several display options. In this example, icon 46 may correspond to a request for displaying layout of a given die on the leather hide 30. Icon 47 corresponds to a request for free hand draw. Icon 44 requests displaying a 1 inch diameter mark to identify a defect of the leather hide 30. Icon 45 requests displaying a 3 inch diameter mark to identify a defect of the leather hide 30. Icon 48 requests displaying a variable diameter mark to identify a defect of the leather hide 30, which may be controlled, for example, by duration of the request. Icon 49 requests displaying a complete layout of all defects and all die locations. It should be understood that the term “icon” as used herein generally refers to graphic symbols such as are shown in FIG. 2B. However, the term “icon” may also be considered to refer to text, or any other type indicia. What is important is that the operator is provided with a variety of options by the laser projector 22 at a location adjacent to where the operator 36 is performing the work.

As shown in FIG. 2B, the operator 36 has placed the reflector 38 at the laser beam 25 for and in the location of icon 46. A reflected beam 40 is returned to the laser projector 22 and to the accompanying sensor. Laser projector 22 communicates with controller 24 to provide the signal. Controller 24 then drives the laser projector 22 to display the display option associated with icon 46.

As shown in FIG. 2C, the controller 24 has configured the laser projector 22 to only display the die locations 28, 29 and 31. This is the display option associated with icon 46. When the operator 36 has completed work associated with this option, the operator 36 may again place the reflector 38 in the vector path of the beam 25 to request the menu 42.

The foregoing represents one example of bi-directional communication with the laser system 20. While the embodiment of the laser assisted assembly system 20 is useful in a leather processing system is disclosed herein, many other embodiments of assembly systems may be used. Generally, assembly systems chosen for operation in the leather processing system disclosed herein may be selected according to the needs of a user, designer, manufacturer or other similarly interested party.

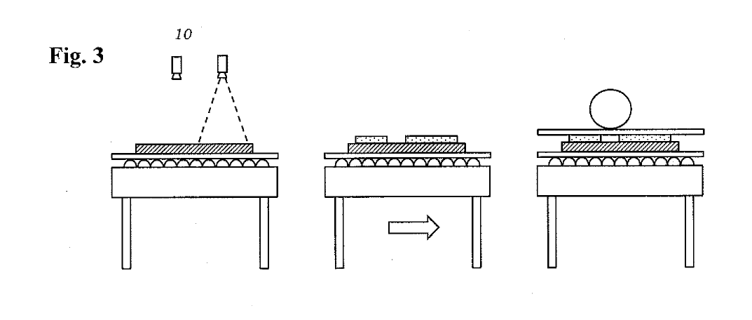

Refer now to FIG. 3 which provides a side view of an exemplary and non-limiting embodiment of a leather processing system 100. In the exemplary embodiment of the 711759-001480 leather processing system 100, a first die station 1, a second die station 2, and a third die station 3 are provided.

At the first die station 1, a digital camera 10 and at least one laser projector 22 are mounted over table 34. An appropriate source of illumination (not shown) may be included to ensure efficient operation of the digital camera 10.

Generally, the digital camera 10 includes apparatus appropriately configured for inspection of an entire leather hide. Accordingly, the digital camera 10 may be a “high resolution” digital camera (for example, of a sufficiently high pixel count to enable the teachings herein). Additionally, the digital camera 10 may include external optics and other apparatus as necessary to enhance machine vision. The digital camera 10 is not limited to one sensor (such as a charge coupled device (CCD) or complimentary metal oxide sensor (CMOS)) and may include a plurality of sensors. It is not required that all sensors be co-located. Generally, as discussed herein, the term “digital camera” generally refers to apparatus deemed to be appropriate for collecting images as described herein. Generally, the digital camera 10 is operationally coupled to the controller 24. That is, the digital camera 10 is configured to provide images 26 to the controller 24.

At the first die station 1, an unmarked leather hide 30 is nested on the table 34 below the digital camera 10, and on top of a die board 56. In this embodiment, an inspector uses a stylus (not shown) to encircle flaws and defects on the unmarked leather hide 30. The controller 24 is configured to capture and recognize the images of the encircled flaws on the leather hide 30. The controller 24 processes the images 26 of the path followed by the stylus.

In some embodiments, the table 34 includes a two-dimensional array of sensors. That is, in some embodiments, the table 34 may be configured with a plurality of sensors for sensing drawing or scribing of the stylus. Accordingly, the table 34 (and the sensors therein) may also be coupled to the controller 24. In some other embodiments, the controller 24 is configured to monitor output of the digital camera 10 and identify gestures or other input that will signify marking of the leather hide 30. In some embodiments, the leather hide 30 is marked with invisible ink (such as a composition that may be sensed only in the infrared).

In some further embodiments, such as those with appropriate illumination, the controller 24 includes an appropriate algorithm for identifying defects in the leather hide 30. For example, for one type of defect such as discoloration, the controller 24 may produce an average color for an entire leather hide 30. By using a particular algorithm, the controller 24 may be configured to identify small groupings of pixels in any one image 26 that are beyond a certain tolerance level. Similarly, striations, creases, holes and other defects common to a leather hide 30 may be identified. Accordingly, the controller 24 may make use of a plurality of algorithms, routines, analyses or other techniques for evaluating quality of the leather hide 30.

In short, in some embodiments, an overall shape of the leather hide 30 and the location of any defects are determined at the first die station 1. Determination of the overall shape and the defect map provides for a “map” of the leather hide 30. Each map is then associated with the respective leather hide 30.

Maps may be produced. by physically marking the hide with chalk, crayon, marker or the like. In some embodiments, the controller 24 obtains the map via the camera 10 for a digital representation. In some embodiments, a map can be obtained by digitizing flaws (physically marking or non-marking means) where the camera 10 or sensing device (electrical, optical or other) follows a cursor controlled by the operator 36. In these embodiments, the map is generally combined with an outline of the perimeter of the bide 60 that is obtained from the camera 10 to build the complete map.

Once the leather hide 30 has been mapped, it is available for job fulfillment. That is, the controller 24 is provided with requirements for each job. The requirements may include a listing of the shape and size and number of products to be delivered. Accordingly, fulfillment of job requirements will most often involve processing of a plurality of leather hides 30. As a matter of convention, processing of any one leather hide 30 is referred to herein as a single “run,” while a plurality of runs may be required to complete a job.

At a second die station 2, die mapping and set up for a given run is performed. Here, job requirements are correlated with the map of the respective leather hide 30. Once the job requirements for the respective leather hide 30 have been identified, a plurality of dies 54 are selected for the run. The controller 24 may then cause the laser projector 22 to perform certain tasks. For example, the laser projector 22 may be tasked with illuminating an appropriate die 54 for placement. That is, the laser projector 22 may illuminate the appropriate die 54 within a die storage area. As a part of this mode of operation, the operator 36 may then take the appropriate die 54 and properly position the die 54 on the leather hide 30. The digital camera 10 may be used by the controller 24 to verify appropriate positioning of the die 54. Incorrect location of placement of the die 54 may result in halting of the run, display of error messages and the like. Once the die 54 is properly placed on the leather hide 30, the operator 36 may signal the digital camera 10, a user input device, a remote device, or other such device to advance the process of die selection.

In general, the controller 24 is configured to identify which die to place next on the hide 60 and the location of that die within the storage system. The laser projector 22 may be used to identify the specific die for the operator 36, but there are other techniques that may be used to identify the proper die to the operator 36.

In some embodiments, robotic systems (not shown) are coupled with the controller 24. The robotic systems provide for retrieval and placement of the plurality of dies 54 on the given leather hide 30. Again, verification may be performed using the digital camera 10.

Regardless of how the dies 54 are assembled on the leather hide 30, once the maximum number of proper dies is placed on the leather hide 30 the assembly consisting of the die board, the leather hide 30, and the dies 54 is sent to a press 5. The press 5 performs pressing at the third die station 3.

At the third die station 3, the press 5 is placed on top of the die 54 and pressed onto the dies 54, thus resulting in various shaped pieces (not shown) of the leather hide 30.

Having thus described aspects of an exemplary embodiment, some additional aspects and embodiments are now introduced.

In some embodiments, mapping of a plurality of leather hides 30 is completed prior to processing of any one leather hide 30. Advantageously, the controller 24 may use mapping of each of the leather hides 30 to provide a “job map.” That is, the controller 24 may be configured to make the most efficient use of the entire plurality of leather hides 30 to complete job fulfillment, as opposed to efficient use of each leather hide 30 on a one-at-a-time basis.

Advantageously, the laser system 22 may be used to illuminate each one of the leather hides 30 with a plurality of images 26. Accordingly, the leather processing system 100 may be configured such that marking of the leather hides 30 is not required. Accordingly, the leather processing system 100 may save on use of conventional marketing materials, and provide for dynamic reconfiguration of leather processing arrangements.

It should be understood that while described in terms of a first, second and third die station, such description is merely illustrative and introductory. Accordingly, additional aspects may be employed at any one of the stations. Further, some aspects may be addressed in an alternative fashion, such as prior to the leather processing system shown in FIG. 3. For example, mapping of each one of the leather hides 30 may be performed at least in part prior to introduction of the leather hide 30 at the first die station 1. More specifically, and by way of example, in some embodiments, manual inspection of the leather hides 30 may be performed upstream. In some of these embodiments, the leather processing system 100 is configured to recognize particular marks provided by a vendor of the leather hides 30.

Generally, the leather processing system 100 provides for automated or semi-automated leather processing. That is, the leather processing system 100 may be configured for performing at least some of the steps that have traditionally required human intervention.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Various other components may be included and called upon for providing for aspects of the teachings herein. For example, additional materials, combinations of materials and/or omission of materials may be used to provide for added embodiments that are within the scope of the teachings herein.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While embodiments of the disclosure have been described with reference to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the scope thereof. Therefore, it is intended that the disclosure not be limited to the particular embodiment disclosed as the best mode contemplated for carrying out such embodiment, but that the disclosure include all embodiments falling within the scope of the appended claims.

What is claimed is:

1. A processing system for processing a leather hide, the processing system comprising:
a laser system configured for illuminating the leather hide with location information for placement of a die.

2. The processing system as in claim 1, wherein the laser system includes at least one of a camera, at least one laser projector, and a computer for controlling the system.

3. The processing system as in claim 1, wherein the location information is displayed as at least one of a graphic, a symbol and a design.

4. The processing system as in claim 1, wherein the laser system is further configured to illuminate the leather hide using projected iconic feedback.

5. The processing system as in claim 1, further comprising instructions for correlating placement of a plurality of dies with a job description.

6. The processing system as in claim 1, further comprising instructions for identifying at least one defect in the leather hide.

7. The processing system as in claim 1, further comprising instructions for mapping a plurality of defects in the leather hide.

8. The processing system as in claim 1, further comprising machine readable instructions for correlating a defect map with the leather hide.

9. The processing system as in claim 8, wherein the location information accounts for defects identified within the defect map.

10. A method for processing a leather hide, the method comprising:
illuminating the leather hide with location information from a laser system; and,
placing at least one die upon the leather hide according to the location information.

11. The method as in claim 10, further comprising pressing the at least one die into the leather hide to provide at least one workpiece.

12. The method as in claim 10, wherein the illuminating further comprises providing at least one of an icon, a symbol and a design.

13. The method as in claim 10, further comprising receiving user input and adjusting the illuminating according to the input.

14. The method as in claim 10, further comprising mapping placement of a plurality of dies upon the leather hide.

15. The method as in claim 10, wherein the location information is determined according to defect information for the leather hide.

16. A computer program product stored on non-transient machine readable media, the computer program product comprising machine executable instructions for processing a leather hide, the instructions comprising instructions for:
operating a laser system for illuminating the leather hide with location information; and,
adjusting operation of the laser system according to user input.
